(19) United States
(12) Patent Application Publication
(10) Pub. No.: US 2025/0029777 A1
(43) Pub. Date: Jan. 23, 2025

(54) COIL COMPONENT

(71) Applicant: SAMSUNG ELECTRO-MECHANICS CO., LTD., Suwon-si (KR)

(72) Inventors: Tae Hyun Kim, Suwon-si (KR); Dong Hwan Lee, Suwon-si (KR); Dong Jin Lee, Suwon-si (KR); Soon Kwang Kwon, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/650,754

(22) Filed: Apr. 30, 2024

(30) Foreign Application Priority Data
Jul. 20, 2023 (KR) 10-2023-0094559
Nov. 15, 2023 (KR) 10-2023-0158359

(51) Int. Cl. H01F 27/29; H01F 27/32

(52) U.S. Cl. CPC H01F 27/292; H01F 27/324

(57) ABSTRACT

According to an aspect of the present disclosure, a coil component includes a body including a first surface and a second surface opposing each other in a first direction, and a third surface connecting the first surface to the second surface; a coil disposed in the body and including a lead-out portion led out to the first surface or the second surface; and an external electrode disposed on the body and connected to the lead-out portion and including a first metal layer and a second metal layer. The first metal layer includes a first side surface facing the body and a second side surface opposing the first side surface, and the second metal layer is disposed on each of the first side surface and the second side surface of the first metal layer.

### CROSS-REFERENCE TO RELATED APPLICATION(S)

This application claims benefit of priority to Korean Patent Application No. 10-2023-0158359 filed on Nov. 15, 2023 and Korean Patent Application No. 10-2023-0094559 filed on Jul. 20, 2023 in the Korean Intellectual Property Office, the disclosures of which are incorporated herein by reference in their entirety.

### TECHNICAL FIELD

The present disclosure relates to a coil component.

### BACKGROUND

An inductor, a coil component, may be a representative passive electronic component used in an electronic device along with a resistor and a capacitor.

As an electronic device has been designed to have high-performance and a reduced size, the number of electronic components used in an electronic device has increased and a size thereof has been reduced.

Meanwhile, a thin-film coil component in which a coil is plated on a support member may be easily miniaturized, but coupling force between an external electrode and a coil may be reduced. Accordingly, there has been demand for a structure having strengthened coupling force to maintain connection reliability between a coil and an external electrode despite vibrations or shocks.

### SUMMARY

An aspect of the present disclosure is to a coil component in which connection reliability may be maintained between a coil and an external electrode in the coil component despite vibrations or external impacts.

An aspect of the present disclosure is to strengthen physical coupling force between a body and an external electrode by bending one region of an end of the external electrode toward a recess formed in the body.

According to an aspect of the present disclosure, a coil component includes a body including a first surface and a second surface opposing each other in a first direction, and a third surface connecting the first surface to the second surface; a coil disposed in the body and including a lead-out portion led out to the first surface or the second surface; and an external electrode disposed on the body and connected to the lead-out portion and including a first metal layer and a second metal layer. The first metal layer includes a first side surface facing the body and a second side surface opposing the first side surface, and the second metal layer is disposed on each of the first side surface and the second side surface of the first metal layer.

According to another aspect of the present disclosure, a coil component includes a body including a first surface and a second surface opposing each other in a first direction, and a third surface connecting the first surface to the second surface; a coil disposed in the body and including a lead-out portion led out to the first surface or the second surface; a conductive resin layer disposed on the body and connected to the lead-out portion; and an external electrode disposed on the conductive resin layer and including a first metal layer and a second metal layer. The first metal layer includes a first side surface facing the body and a second side surface opposing the first side surface, the second metal layer is disposed on each of the first side surface and the second side surface of the first metal layer, and the conductive resin layer is disposed between the lead-out portion and the second metal layer, and includes at least a portion extending to the third surface.

According to another aspect of the present disclosure, a coil component includes a body including a first surface and a second surface opposing each other in a first direction, and a third surface connecting the first surface to the second surface; a coil disposed in the body and including a lead-out portion led out to the first surface; an external electrode disposed on the first surface and the third surface to connect to the lead-out portion; and an adhesive layer disposed between the third surface of the body and the external electrode. A grain included in the external electrode, disposed on the first surface of the body, has a long axis aligned parallel to the first surface of the body.

According to another aspect of the present disclosure, a coil component

includes a body including a first surface and a second surface opposing each other in a first direction, and a third surface and a fourth surface opposing each other and connected to the first surface and the second surface; a coil disposed in the body and including a lead-out portion led out to the first surface; an external electrode disposed on the first surface, on the third surface to connect to the lead-out portion, and on the fourth source;

and an adhesive layer disposed between the third surface of the body and the external electrode. An end portion of the external electrode is disposed in a recess in the fourth surface.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is an exploded perspective diagram in FIG. 1;

FIG. 3 is an L-T cross-sectional diagram illustrating a first external electrode;

FIG. 4 is a cross-sectional diagram taken along line I-I′ in FIG. 1;

FIG. 5 is a cross-sectional diagram taken along line II-II′ and an enlarged diagram illustrating region A in FIG. 1;

FIG. 6 is an enlarged diagram illustrating region B and region C in FIG. 5;

FIG. 7 is an enlarged diagram illustrating an L-T cross-section and region D of a coil component according to a second embodiment of the present disclosure, corresponding to FIG. 5;

FIG. 8 is a diagram illustrating an L-T cross-section of a coil component according to a third embodiment of the present disclosure, corresponding to FIG. 7;

FIG. 9 is a diagram illustrating an L-T cross-section of a coil component according to a fourth embodiment of the present disclosure, corresponding to FIG. 5;

FIG. 10 is a diagram illustrating an L-T cross-section of a coil component according to a modified example of a fourth embodiment of the present disclosure, corresponding to FIG. 9;

FIG. 11 is a diagram illustrating an L-T cross-section of a coil component according to a fifth embodiment of the present disclosure, corresponding to FIG. 9;

FIG. 12 is a diagram illustrating an L-T cross-section of a coil component according to a modified example of a fifth embodiment of the present disclosure, corresponding to FIG. 11; and

FIGS. 13 and 14 are diagrams illustrating a portion of processes of a method of manufacturing a coil component according to a first embodiment of the present disclosure.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An expression used in the singular encompasses the expression of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the expression that an element is disposed “on” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

For example, structures, shapes, and sizes described as examples in embodiments in the present disclosure may be implemented in another exemplary embodiment without departing from the spirit and scope of the present disclosure.

In the drawings, the L direction may be defined as a first direction or a length direction, the W direction may be defined as a second direction or a width direction, and the W direction may be defined as a third direction or a thickness direction.

In the drawings, the same elements will be indicated by the same reference numerals. Also, redundant descriptions and detailed descriptions of known functions and elements that may unnecessarily make the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

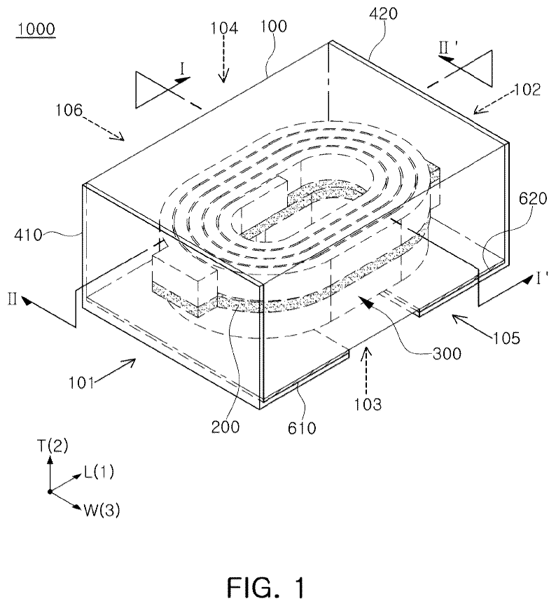

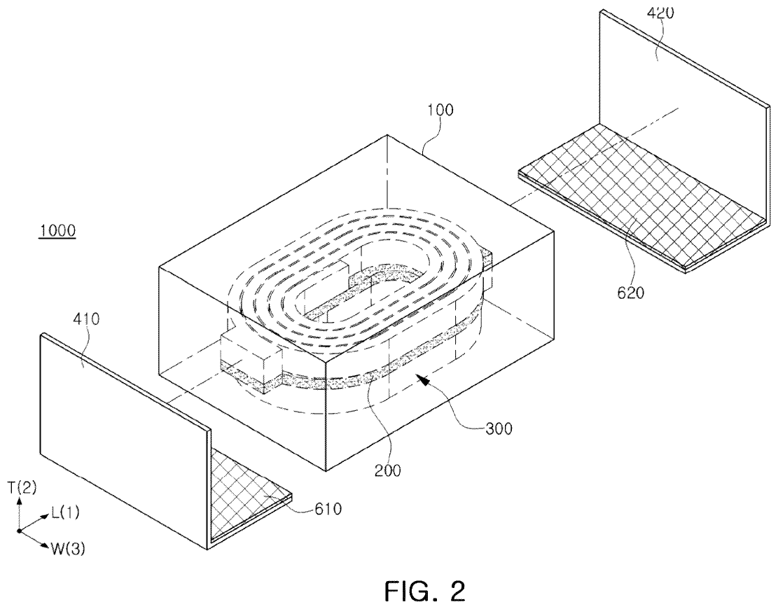

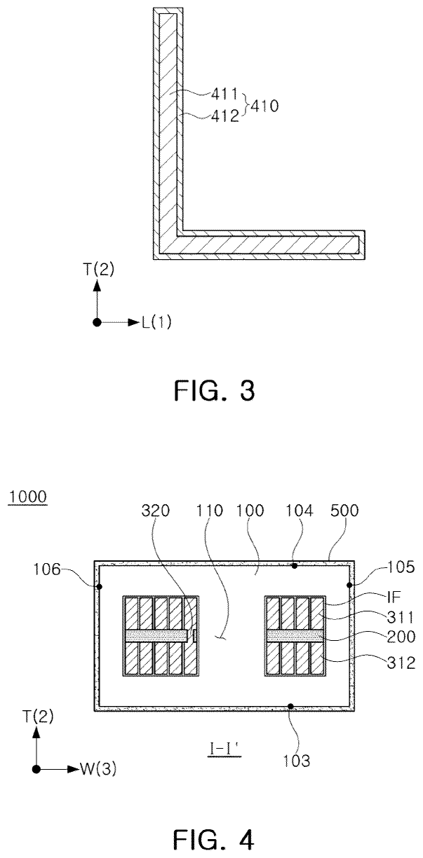

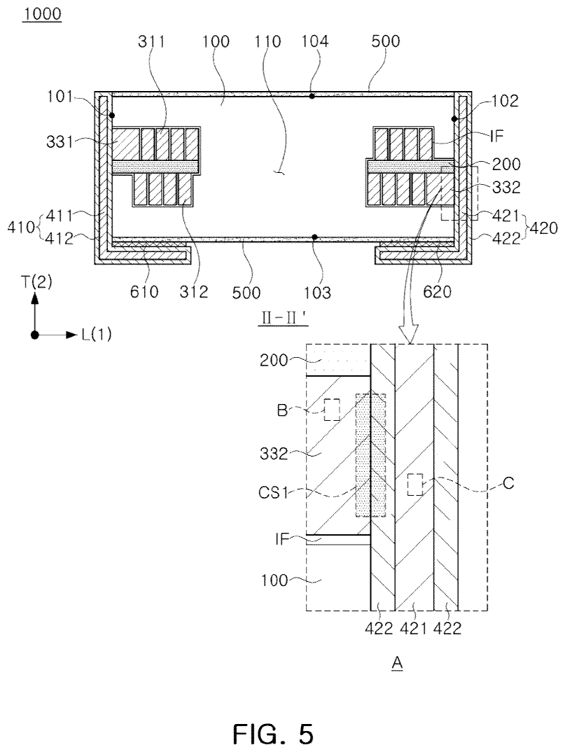

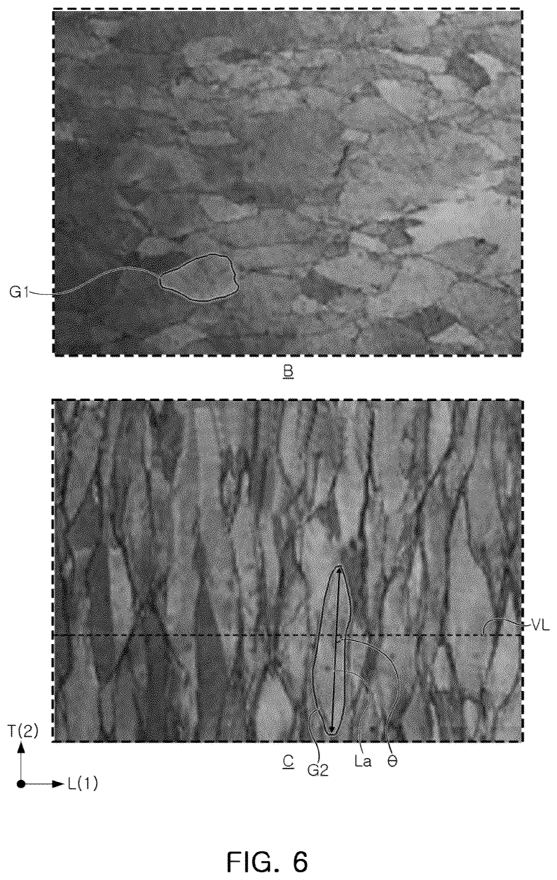

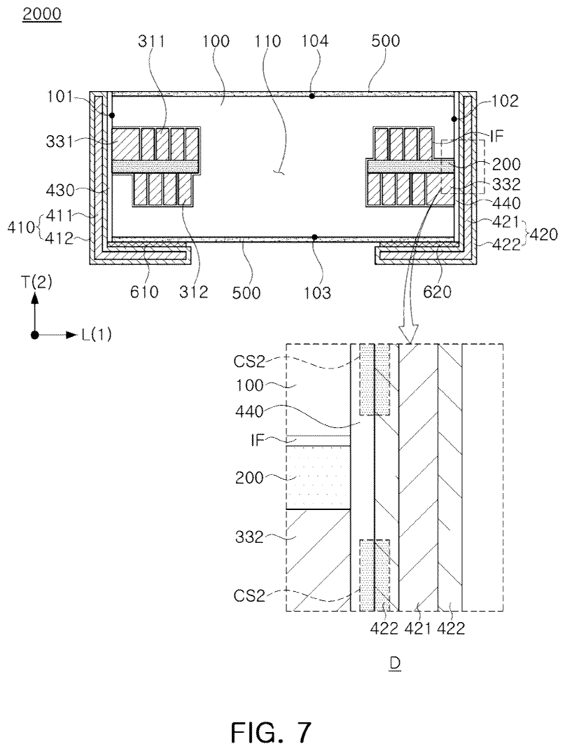

FIG. 1 is a perspective diagram illustrating a coil component according to a first embodiment. FIG. 2 is an exploded perspective diagram in FIG. 1. FIG. 3 is an L-T cross-sectional diagram illustrating a first external electrode. FIG. 4 is a cross-sectional diagram taken along line I-I′ in FIG. 1. FIG. 5 is a cross-sectional diagram taken along line II-II′ and an enlarged diagram illustrating region A in FIG. 1. FIG. 6 is an enlarged diagram illustrating region B and region C in FIG. 5. FIG. 7 is an enlarged diagram illustrating an L-T cross-section and region D of a coil component according to a second embodiment, corresponding to FIG. 5.

In FIGS. 1 and 2, an insulating layer 500 on a body 100 applicable to the embodiment may not be shown to more clearly illustrate coupling between components.

Referring to FIGS. 1 to 6, a coil component 1000 according to the first embodiment may include a body 100, a coil 300, and external electrodes 410 and 420, and may further include a support member 200, an insulating layer 500, and an adhesive layer 610 and 620.

The coil component 1000 according to the embodiment may have a structure in which the external electrodes 410 and 420, including the first metal layers 411 and 421 and the second metal layers 412 and 422 coating the same, may be formed separately through a process such as rolling, and may be fused to the lead-out portions 331 and 332 exposed by the body 100 through ultrasonic welding, laser welding, or resistance welding, differently from the structure in which external electrodes 410 and 420 are formed by plating on the body 100.

Accordingly, in the coil component 1000 in the embodiment, the external electrodes 410 and 420 may be formed through a process such as rolling, such that a long axis direction of grains included in the first metal layers 411 and 421 of the external electrodes 410 and 420 may be formed parallel to the surface of body 100.

Also, the lead-out portions 331 and 332 and the external electrodes 410 and 420 may be in contact with and connected to by fusion by ultrasonic welding, laser welding, or resistance welding, such that a homogeneous solid solution may be formed in a region in which the lead-out portions 331 and 332 and the second metal layers 412 and 422 may be in contact with each other.

Through the above structure, the coil component 1000 in the embodiment may have strong properties against vibrations or external impacts as coupling force and connection reliability between the coil 300 and the external electrodes 410 and 420 are improved.

In the description below, main components included in the coil component 1000 according to the embodiment will be described in detail.

The body 100 may form an exterior of the coil component 1000 in the embodiment, and the coil 300 and the support member 200 may be disposed therein.

The body 100 may have a hexahedral shape.

The body 100 may include a first surface 101 and a second surface 102 opposing each other in the length direction (L, the first direction), a third surface 103 and a fourth surface 104 opposing each other in the thickness direction (T, the second direction), and a fifth surface 105 and a sixth surface 106 opposing each other in the width direction (W, the third direction). Each of the first to fourth surfaces 101, 102, 103 and 104 of the body 100 may be a wall surface of the body 100 connecting the first surface 101 and the second surface 102 of the body 100.

The body 100 may be formed such that the coil component in which the external electrodes 410 and 420 are formed may have a length of 2.5 mm, a width of 2.0 mm and a thickness of 0.8 mm, may have a length of 2.0 mm, a width of 1.2 mm and a thickness of 1.0 mm, may have a length of 2.0 mm, a width of 1.2 mm and a thickness of 0.6 mm, may a length of 1.6 mm, a width of 0.8 mm and a thickness of 0.6 mm, may have a length of 1.6 mm, a width of 0.8 mm and a thickness of 0.4 mm, may have a length of 1.4 mm, a width of 1.2 mm and a thickness of 0.65 mm, may have a length of 1.0 mm, a width of 0.7 mm and a thickness of 0.65 mm, may have a length of 0.8 mm, a width of 0.4 mm and a thickness of 0.65 mm, or may have a length of 0.8 mm, a width of 0.4 mm and a thickness of 0.5 mm, but an embodiment thereof is not limited thereto.

As the above-described exemplary dimensions for the length, width and thickness of coil component 1000 may refer to dimensions not reflecting process errors, dimensions in the range recognized as process errors may correspond to the above-described example dimensions.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the thickness of the coil component 1000 may refer to a minimum value among the dimensions of the plurality of line segments described above. Alternatively, the thickness of the coil component 1000 may refer to an arithmetic mean value of at least three or more of the dimensions of the plurality of line segments described above. Here, the plurality of line segments parallel to the thickness direction T may be spaced apart from each other by an equal distance in the length direction L, but an embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the length direction L, but an embodiment thereof is not limited thereto.

Alternatively, each of the length, a width and thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include a magnetic material and resin. Specifically, the body 100 may be formed by laminating one or more magnetic composite sheets in which a magnetic material is dispersed in an insulating resin. The body 100 may have a structure other than a structure in which a magnetic material is dispersed in resin. For example, the body 100 may be formed of a magnetic material such as ferrite.

The magnetic material may be ferrite or metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

The resin may include epoxy, polyimide, a liquid crystal polymer, or the like, alone or in combination but an embodiment thereof is not limited thereto.

The body 100 may include a first core 110 penetrating through the support member 200 and the coil 300. The first core 110 may be formed by filling the through hole in the support member 200 and the coil 300 with a magnetic composite sheet, but an embodiment thereof is not limited thereto.

The support member 200 may be disposed in the body 100. The support member 200 may be a component supporting the coil 300. The support member 200 may be excluded in embodiments, such as when coil 300 corresponds to a wound coil or has a coreless structure.

The support member 200 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the support member 200 may be formed of an insulating material such as prepreg, Ajinomoto build-up film (ABF), FR-4, bismaleimide triazine (BT) film, and photo imaginable dielectric (PID) film, but an embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the support member 200 is formed of an insulating material including a reinforcing material, the support member 200 may provide improved rigidity. When the support member 200 is formed of an insulating material not including glass fibers, a thickness of a component may be easily reduced by reducing an overall thickness of the support member 200 and the coil 300 (indicating a sum of dimensions of the coil 300 and the support member 200 in the first direction T in FIG. 1). When the support member 200 is formed of an insulating material including a photosensitive insulating resin, the number of processes for forming the coil 300 may be reduced, which may be advantageous in reducing production costs, and a fine via 320 may be formed. The thickness of the support member 200 may be, for example, 10 μm or more and 50 μm or less, but an embodiment thereof is not limited thereto.

The coil 300 may be disposed on the support member 200. The coil 300 may be buried in body 100 and may exhibit properties of a coil component. For example, when the coil component 1000 in the embodiment is used as a power inductor, the coil 300 may store an electric field as a magnetic field and maintain an output voltage, thereby stabilizing power supply of an electronic device.

The coil 300 may be formed on at least one of both surfaces of the support member 200 opposing each other, and may form at least one turn. In the case in the embodiment, the coil 300 may include coil patterns 311, 312, via 320, and lead-out portions 331 and 332.

Referring to FIGS. 1, 4 and 5, each of the first coil pattern 311 and the second coil pattern 312 may be disposed on both surfaces of the support member 200 opposing each other, and may be in the form of a planar spiral forming at least one turn around the core 110 of the body 100. For example, with respect to the direction in FIG. 1, the first coil pattern 311 may be disposed on an upper surface of the support member 200 and may form at least one turn around the core 110. The second coil pattern 312 may be disposed on a lower surface of the support member 200 and may form at least one turn around the core 110. The first and second coil patterns 311 and 312 may be formed such that ends of outermost turns connected to the lead-out portions 331 and 332 may extend in directions of the first surface 101 and the second surface 102 of the body 100, respectively.

The lead-out portions 331 and 332 may extend from the coil patterns 311 and 312 to the first surface 101 or the second surface 102 of the body 100.

Specifically, the first lead-out portion 331 may extend from an outer end of the first coil pattern 311 to the first surface 101 of the body 100 and may be connected to the first external electrode 410. Also, the first lead-out portion 331 may be formed integrally with the first coil pattern 311.

Similarly, the second lead-out portion 332 may extend from an outer end of the second coil pattern 312 to the second surface 102 of the body 100 and may be connected to the second external electrode 420. Also, the second lead-out portion 332 may be formed integrally with the second coil pattern 312.

Referring to FIG. 4, the coil 300 may further include a via 320 connecting the first coil pattern 311 to the second coil pattern 312. Specifically, the via 320 may connect inner ends of innermost turns of each of the first and second coil patterns 311 and 312 to each other through the support member 200. Accordingly, a signal input to the first external electrode 410 may be output to the second external electrode 420 through the first lead-out portion 331, the first coil pattern 311, the via 320, the second coil pattern 312, and the second lead-out portion 332. Through this structure, each component of coil 300 may function as a single coil connected between the first and second external electrodes 410 and 420.

At least one of the coil patterns 311, 312, via 320, and the lead-out portions 331 and 332 may include at least one conductive layer.

As an example, when forming the first coil pattern 311, via 320, and the first lead-out portion 331 by plating on an upper surface of the support member 200 (with respect to the direction in FIG. 1), each of the first coil pattern 311, the via 320, and the first lead-out portion 331 may include a seed layer and an electroplating layer. The seed layer may be formed by electroless plating or vapor deposition methods such as sputtering. Each of the seed layer and the electroplating layer may have a single-layer structure or a multi-layer structure. An electroplating layer having a multi-layer structure may be formed as a conformal film structure in which one electroplating layer is covered by another electroplating layer, or may be formed in a shape in which another electroplating layer is laminated to only one surface of one electroplating layer. The seed layer of the first coil pattern 311, the seed layer of the via 320, and the seed layer of the first lead-out portion 331 may be formed integrally, and boundaries may not be formed therebetween, but an embodiment thereof is not limited thereto. The electroplating layer of the first coil pattern 311, the electroplating layer of via 320, and the electroplating layer of first lead-out portion 331 may be formed integrally, and boundaries may not be formed therebetween, but an embodiment thereof is not limited thereto.

Each of the coil patterns 311, 312, via 320, and the lead-out portions 331 and 332 may include a conductive material such as copper (Cu), aluminum (Al), silver (Ag), tin (Sn), gold (Au), nickel (Ni), lead (Pb), titanium (Ti), chromium (Cr), molybdenum (Mo) or alloys thereof, but is not limited thereto.

Referring to FIGS. 1, 2, and 5, the coil component 1000 according to the embodiment may be disposed on the body 100 and may include the external electrodes 410 and 420 connected to the coil 300.

The external electrodes 410 and 420 may be components electrically connecting the coil component 1000 to a circuit substrate when the coil component 1000 according to the embodiment is mounted on the circuit substrate. For example, the first and second external electrodes 410 and 420, spaced apart from each other on the third surface 103 of the body 100, and a connection portion of the circuit substrate may be electrically connected to each other.

Specifically, the first external electrode 410 may be disposed on the first surface 101 of the body 100, and may be in contact with and connected to the first lead-out portion 331 extending to the first surface 101 of the body 100, and the second external electrode 420 may be disposed on the second surface 102 of the body 100 and may be in contact with and connected to the second lead-out portion 332 extending to the second surface 102 of the body 100.

The first external electrode 410 may be disposed on the first surface 101 of the body 100 and may extend to at least a portion of the third surface to the sixth surface 103, 104, 105, and 106 of the body 100.

The second external electrode 420 may be disposed on the second surface 102 of the body 100 and may extend to at least a portion of the third surface to the sixth surface 103, 104, 105, and 106 of the body 100.

A region in which the first external electrode 410 extends to at least a portion of the third surface to the sixth surface 103, 104, 105, and 106 of the body 100, and a region in which the second external electrode 420 extends to at least a portion of the third surface to the sixth surface 103, 104, 105, and 106 of the body 100 may be spaced apart from each other.

Referring to FIGS. 1, 2 and 5, the coil component 1000 according to the embodiment may have the first and second external electrodes 410 and 420 disposed on the first surface 101 and the second surface 102 of the body 100, respectively, may have a structure extending only to the third surface 103 of the body 100.

In this case, the first external electrode 410 may include a first pad portion disposed on the third surface 103 of the body 100, and a first extension portion disposed on the first surface 101 of the body 100 and connecting the first lead-out portion 331 to the first pad portion.

Also, the second external electrode 420 may include a second pad portion spaced apart from the first pad portion on the third surface 103 of the body 100, and a second extension portion disposed on the second surface 102 of the body 100 and connecting the second lead-out portion 332 to the second pad portion.

The pad portion and the extension portion may be formed together in the same process, and may be integrated with each other without a boundary therebetween.

Referring to FIGS. 3 and 5, the external electrodes 410 and 420 in the embodiment may include first metal layers 411 and 421, and second metal layers 412 and 422.

The first metal layers 411 and 421 of the external electrodes 410 and 420 may include an internal side surface opposing the body 100 and an external side surface opposing an internal side surface, and the second metal layers 412 and 422 of the external electrodes 410 and 420 may be disposed on the internal side surface and the external side surface of the first metal layers 411 and 421, respectively. That is, the second metal layers 412 and 422, the first metal layers 411 and 421, and the second metal layers 412 and 422 may be disposed in order on the external electrodes 410 and 420 with respect to an outer side from the internal side of coil component 1000.

The first metal layers 411 and 421 of the external electrodes 410 and 420 may be coated with the second metal layers 412 and 422. That is, with respect to the L-T cross-section of the coil component 1000 in the embodiment, the second metal layers 412 and 422 of the external electrodes 410 and 420 may be disposed to surround the first metal layers 411 and 421. However, an embodiment thereof is not limited thereto, and the second metal layers 412 and 422 may be disposed to expose a partial region of the first metal layers 411 and 421 on both ends of the external electrodes 410 and 420.

The first metal layers 411 and 421 of the external electrodes 410 and 420 may include copper (Cu), and the second metal layers 412 and 422 may include nickel (Ni). For example, the external electrodes 410 and 420 in the embodiment may correspond to a copper (Cu) surface coated with nickel (Ni).

Referring to FIG. 5, the second metal layers 412 and 422 of the external electrodes 410 and 420 may be in direct contact with the lead-out portions 331 and 332 on the first surface 101 or the second surface 102 of the body 100, and may be fused together through processes such as ultrasonic welding, laser welding, or resistance welding.

Accordingly, the metal included in the lead-out portions 331 and 332 and the metal included in the second metal layers 412 and 422 may form a homogeneous solid solution in regions in contact with each other. Here, a homogeneous solid solution may be a solid solution in which a crystal structure may not change as a single composition is formed no matter what ratio two materials are mixed with.

The enlarged diagram illustrating region A in FIG. 5 illustrates a contact region between the second lead-out portion 332 and the second external electrode 420 in detail, and a homogeneous solid solution region CS1 may be formed in a region in which a metal included in the second lead-out portion 332 and a metal included in the second metal layer 422 of the second external electrode 420 are in contact with each other.

In the region CS1 where the homogeneous solid solution is formed, a point at which a content ratio between the metal included in the second lead-out portion 332 and the metal included in the second metal layer 422 is 1:1 may be present, which may be a characteristic appearing as contents of the two metals change gradually in the homogeneous solid solution region CS1, differently from an intermetallic compound (IMC).

For example, when the second lead-out portion 332 includes copper (Cu) and the second metal layer 422 includes nickel (Ni), when the second lead-out portion 332 and the second external electrode 420 are fused through processes such as ultrasonic welding, laser welding, or resistance welding, copper (Cu) in the second lead-out portion 332 and nickel (Ni) in the second metal layer 422 may form a homogeneous solid solution. In the homogeneous solid solution region CS1, copper (Cu) content may gradually decrease, nickel (Ni) content may gradually increase, and copper (Cu) content may gradually increase from the second lead-out portion 332 to the second metal layer 422, and in the intermediate region, a point at which a content ratio between copper (Cu) and nickel (Ni) is 1:1 may be present.

FIG. 6 is an enlarged diagram illustrating region B included in the second lead-out portion 332 and region C included in the first metal layer 421 in region A in FIG. 5.

Referring to FIG. 6, metal grains G1 and G2 may be observed in the enlarged views of region B and region C, respectively. For example, in the region B, grain G1 of copper (Cu) included in the second lead-out portion 332 may be observed, and in the region C, grain G2 of copper (Cu) included in the first metal layer 421 may be observed.

When comparing the enlarged diagram illustrating region B with the enlarged

diagram illustrating region C, the grain G2 of copper (Cu) included in the first metal layer 421 may have a size greater than that of grain G1 of copper (Cu) included in the second lead-out portion 332 and may have directionality.

The lead-out portions 331 and 332, which are components of coil 300, may be formed by electrolytic plating on the support member 200, while the first metal layer 421 of the external electrodes 410 and 420 may be formed through a rolling process including pressurization and heating by rollers, such that, due to recrystallization action, the size of the grain G2 may increase and may have directionality.

Here, the sizes of grains G1 and G2 may be determined by, for example, a line intercept method, but an embodiment thereof is not limited thereto.

Referring to FIGS. 5 and 6, a long axis La direction of grain G2 included in the first metal layer 421 may be aligned parallel to a surface of the body 100. That is, in the region in which the first metal layer 421 is disposed on the second surface 102 of the body 100, the long axis La direction of grain G2 may be aligned parallel to the second direction T, and in the region in which the first metal layer 421 is disposed on the third surface 103 of the body 100, the long axis La direction of grain G2 may be aligned parallel to the first direction L.

Here, the notion that the long axis La direction of grain G2 included in the first metal layer 421 is aligned parallel to the second direction T may indicate that, with respect to the conceptual extended line VL penetrating the body 100 and parallel to the first direction L, the internal angle (θ) formed between the long axis La of grain G2 included in the first metal layer 421 and the extended line VL may be defined as 80 degrees or more and 110 degrees or less.

Similarly, the notion that the long axis La direction of grain G2 included in the first metal layer 421 is aligned parallel to the first direction L may indicate that, with respect to the conceptual extended line penetrating the body 100 and parallel to the second direction T, the internal angle (θ) formed between the long axis La of grain G2 included in the first metal layer 421 and the extended line may be defined as 80 degrees or more and 110 degrees or less.

In this case, the long axis La of grain G2 included in the first metal layer 421 may refer to a straight line having a maximum length in grain G2, and observation may be performed on an optical microscope image or a scanning electron microscope (SEM) image of an L-T cross-section taken from a W central portion of the coil component 1000 in the third direction.

The internal angle (θ) formed between the conceptual extended line VL perpendicular to the surface of the body 100 and the long axis La of grain G2 may refer to an arithmetic mean value obtained by measuring an angle between the long axis La and the extended line VL for each grain G2 appearing in a region of 20 μm×20 μm or more in the SEM image.

The external electrodes 410 and 420 may be formed by coating the second metal layers 412 and 422 on surfaces of the first metal layers 411 and 421 and performing a rolling process using a roller, but an embodiment thereof is not limited thereto, and the first metal layers 411 and 421 may first be formed through a rolling process, and the second metal layers 412 and 422 may be formed on the surface by a vapor deposition method such as sputtering and/or a plating method.

The external electrodes 410 and 420 formed through the above method may be disposed on the body 100 and may be in contact with and connected to the lead-out portions 331 and 332 by ultrasonic welding, laser welding, or resistance welding. In at least a portion of the contact region between the external electrodes 410 and 420 and the lead-out portions 331 and 332, a homogeneous solid solution may be formed between the metal included in the lead-out portion 331 and 332 and the metal included in the second metal layers 412 and 422 of the external electrodes 410 and 420.

Accordingly, coupling force and connection reliability between the external electrodes 410 and 420 and the lead-out portions 331 and 332 may be improved as compared to forming the external electrodes 410 and 420 by plating.

The coil component 1000 according to the embodiment may further include an insulating layer 500 disposed on the third to sixth surfaces 103, 104, 105, and 106 of the body 100. The insulating layer 500 may be disposed in a region other than the region in which the external electrodes 410 and 420 are disposed among the surfaces of the body 100.

At least a portion of the insulating layer 500 disposed on the third surface to sixth surface 103, 104, 105, and 106 of the body 100 may be formed in the same process, and may be integrated with each other without boundaries therebetween, but an embodiment thereof is not limited thereto.

Referring to FIG. 5, at least a portion of the insulating layer 500 may extend to a region between the third surface 103 of the body 100 and the external electrodes 410 and 420.

When the insulating layer 500 extends to a region between the third surface 103 of the body 100 and the external electrodes 410 and 420, an insulating distance between the first and second external electrodes 410 and 420 may increase, such that current leakage which may occur between the first and second external electrodes 410 and 420 may be effectively prevented.

When the coil component 1000 according to the embodiment includes adhesive layers 610 and 620, which will be described later, the insulating layer 500 may extend to a region between the third surface 103 of the body 100 and the adhesive layers 610 and 620.

When the insulating layer 500 extends to a region between the third surface 103 of the body 100 and the adhesive layers 610 and 620, the effect of preventing current leakage that may occur between the first and second external electrodes 410 and 420 may be increased, and coupling force between the insulating layer 500 and the adhesive layers 610 and 620 may be strong, such that coupling force between the external electrodes 410 and 420 and the body 100 may also be strengthened.

The insulating layer 500 may be formed by methods such as printing, vapor deposition, spray application, and film lamination, but an embodiment thereof is not limited thereto.

The insulating layer 500 may further include thermoplastic resins such as polystyrene resin, vinyl acetate resin, polyester resin, polyethylene resin, polypropylene resin, polyamide resin, rubber resin, and acrylic resin, thermosetting resins such as phenolic resin, epoxy resin, urethane resin, melamine resin, alkyd resin, or the like, and photosensitive resin, paralene, SiOₓ or SiNₓ. The insulating layer 500 may further include an insulating filler such as an inorganic filler, but an embodiment thereof is not limited thereto.

Referring to FIGS. 1, 2, and 5, the coil component 1000 according to the embodiment may further include adhesive layers 610 and 620 disposed between the third surface 103 of the body 100 and the external electrodes 410 and 420. The adhesive layers 610 and 620 may be components for strengthening coupling force between the body 100 and the external electrodes 410 and 420.

Specifically, the first adhesive layer 610 may be disposed between the third surface 103 of the body 100 and the first external electrode 410, and the second adhesive layer 620 may be disposed between the third surface 103 of the body 100 and the second external electrode 420.

The adhesive layers 610 and 620 in the embodiment may include conductive resin or non-conductive resin. As an example, adhesive layers 610 and 620 may include conductive paste. Also, the adhesive layers 610 and 620 may include one or more of epoxy, polyurethane, silicone, polyimide, phenol, and polyester thermosetting resin, but an embodiment thereof is not limited thereto.

Referring to FIGS. 4 and 5, the insulating film IF may be disposed between the coil 300 and the body 100 to cover the coil 300. The insulating film IF may be formed along the surface of the support member 200 and coil 300. The insulating film IF may insulate the coil 300 from the body 100, and may include known insulating materials such as paralene, but an embodiment thereof is not limited thereto. The insulating film IF may be formed by a method such as vapor deposition, but an embodiment thereof is not limited thereto, and the insulating film IF may be formed by laminating an insulating film on both surfaces of the support member 200.

### Second Embodiment

FIG. 7 is an enlarged diagram illustrating an L-T cross-section and region D of a coil component according to a second embodiment, corresponding to FIG. 5.

When comparing FIG. 7 with FIG. 5, the coil component 2000 according to the embodiment may be different in terms of a configuration in which third metal layers 430 and 440 are further interposed between the body 100 and the second metal layers 412 and 422, and a formation position of the homogeneous solid solution region CS2 determined the configuration.

Accordingly, in describing the embodiment, only the formation positions of the third metal layer 430, 440, and the homogeneous solid solution region CS2, which are different from the first embodiment, will be described, and the description in the first embodiment may be applied for the other components.

Referring to FIG. 7, the coil component 2000 according to the embodiment may further include third metal layers 430 and 440 disposed between lead-out portions 331 and 332 and second metal layers 412 and 422.

The third metal layers 430 and 440 may be disposed to cover at least one of a first surface 101 and a second surface 102 of the body 100.

The third metal layer 430, 440 may be formed by electrolytic plating, and may include a conductive material, for example, copper (Cu), aluminum (Al), silver (Ag), tin (Sn), gold (Au), nickel (Ni), lead (Pb), titanium (Ti), chromium (Cr), molybdenum (Mo), or alloys thereof, but are not limited thereto.

The third metal layers 430 and 440 in the embodiment may include the same metal as that of the lead-out portions 331 and 332, and accordingly, connection reliability and physical coupling force between the lead-out portions 331 and 332 and the external electrodes 410 and 420 may be further strengthened.

Referring to FIG. 7, the metal included in the third metal layers 430 and 440 and the metal included in the second metal layers 412 and 422 may form a homogeneous solid solution in regions in contact with each other.

That is, differently from the first embodiment, the homogeneous solid solution region CS2 may be formed between the third metal layers 430 and 440 and the second metal layers 412 and 422.

As an example, referring to the enlarged diagram illustrating region D, a homogeneous solid solution region CS2 may be formed in at least a portion of the region in which the third metal layer 440 and the second metal layer 422 are in contact with each other.

In region CS2 in which the homogeneous solid solution is formed, a point at which a content ratio between the metal included in the third metal layer 440 and the metal included in the second metal layer 422 is 1:1 may be present, which may be a characteristic appearing in the homogeneous solid solution region CS2 as contents of the two metals changes gradually, differently from an intermetallic compound (IMC).

For example, when the third metal layer 440 includes copper (Cu) and the second metal layer 422 includes nickel (Ni), when the third metal layer 440 and the second external electrode 420 are fused through processes such as ultrasonic welding, laser welding, or resistance welding, copper (Cu) of the third metal layer 440 and nickel (Ni) of the second metal layer 422 may form a homogeneous solid solution. In the homogeneous solid solution region CS2, the copper (Cu) content may gradually decrease and the nickel (Ni) content may gradually increase from the third metal layer 440 to the second metal layer 422, and in the intermediate region, a point at which the content ratio between copper (Cu) and nickel (Ni) is 1:1 may be present.

In the coil component 2000 in the embodiment, the third metal layers 430 and 440 corresponding to the pre-plated layer may be first disposed on the body 100 surface on which the lead-out portions 331 and 332 are exposed, that is, the first surface 101 and the second surface 102, thereafter, the separately formed external electrodes 410 and 420 may be fused to the third metal layer 430 and 440 by ultrasonic welding, laser welding, or resistance welding, such that the area of the fusion surface may increase, and connection reliability and coupling force between the coil 300 and the external electrodes 410 and 420 may be further strengthened.

### Third Embodiment

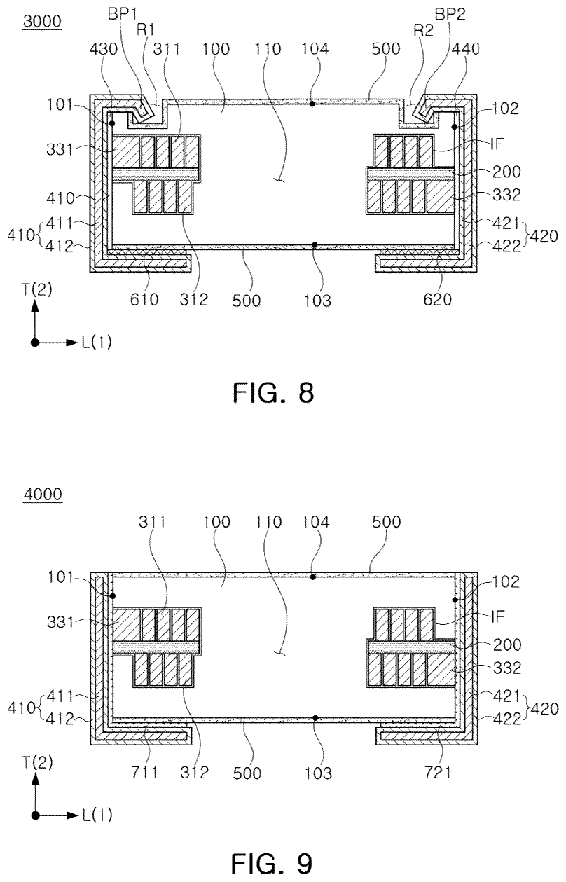

FIG. 8 is a diagram illustrating an L-T cross-section of a coil component according to a third embodiment, corresponding to FIG. 7.

When comparing FIG. 8 with FIG. 7, the coil component 3000 according to the embodiment may be different from the second embodiment in terms of a configuration in which recesses R1 and R2 are formed on the body 100, and a configuration including bent portions BP1 and BP2 includes external electrodes 410 and 420 extending to the recesses R1 and R2.

Accordingly, in describing the embodiment, only the recesses R1, R2, and the bent portions BP1 and BP2 extended to the recesses R1 and R2, which are different from the second embodiment, will be described, and the descriptions in the second embodiment may be applied for the other components.

Referring to FIG. 8, an upper surface of the body 100, that is, the fourth surface 104, may include at least one recess R1 and R2. The recesses R1 and R2 in the embodiment may be formed in the body 100 and may further generate physical fixing force between the body 100 and the external electrodes 410 and 420 by accommodating a portion of the external electrodes 410 and 420.

At least a portion of the external electrodes 410 and 420 may extend into the recesses R1 and R2. Also, the recesses R1 and R2 may be spaced apart from the first surface 101 and the second surface 102 of the body 100, respectively. Also, the recesses R1 and R2 may extend to the fifth surface 105 and the sixth surface 106 of the body 100.

Specifically, the first and second recesses R1 and R2 may be formed on the fourth surface 104 of the body 100 in the embodiment, and the first recess R1 may be spaced apart from the first surface 101 of the body 100 at a predetermined distance, and may accommodate and secure at least a portion of the first external electrode 410 end. For example, the portion of the first external electrode 410 disposed in the first recess R1 in the fourth surface 104 may include a portion spaced apart from a wall surface of the first recess R1 which is closer to the first surface 101 as compared to the portion which is spaced apart from the wall surface of the first recess R1. Similarly, the second recess R2 may be spaced apart from the second surface 102 of the body 100 at a predetermined distance, and may accommodate and secure at least a portion of the end of the second external electrode 420. For example, the portion of the second external electrode 420 disposed in the second recess R2 in the fourth surface 104 may include a portion spaced apart from a wall surface of the second recess R2 which is closer to the second surface 102 as compared to the portion which is spaced apart from the wall surface of the second recess R2.

Referring to FIG. 8, the external electrodes 410 and 420 in the embodiment may include the bent portions BP1 and BP2 formed at one end, and the bent portions BP1 and BP2 may be bent toward the recesses R1 and R2.

Specifically, the first external electrode 410 may be disposed on the first surface 101 of the body 100, the first surface 101 of the body 100 and the first recess R1 may extend to the fourth surface 104 of the body 100 along regions spaced apart from each other, and the extended end may include the first bent portion BP1 bent to be accommodated in the first recess R1.

Similarly, the second external electrode 420 may be disposed on the second surface 102 of the body 100, and the second surface 102 of the body 100 and the second recess R2 may extend to the fourth surface 104 of the body 100 along the regions spaced apart from each other. The extended end may include a second bent portion BP2 bent to be accommodated in the second recess R2.

The angle at which bent portions BP1 and BP2 are bent may be selected without limitation in the range of 0 degrees and less than 180 degrees, as long as physical fixing force may be provided between bent portions BP1 and BP2 and recesses R1 and R2 at the angle.

In the coil component 3000 according to the embodiment, recesses R1 and R2 may be formed on the body 100, and as the bent portions BP1 and BP2 formed at the ends of the external electrodes 410 and 420 are accommodated in the recesses R1 and R2, additional physical fixing force may be provided between the body 100 and the external electrodes 410 and 420, such that resistance against external impacts or vibrations may be strengthened.

### Fourth Embodiment and Modified Example

FIG. 9 is a diagram illustrating an L-T cross-section of a coil component according to a fourth embodiment, corresponding to FIG. 5.

When comparing FIG. 9 with FIG. 5, adhesive layers 610 and 620 disposed on the third surface 103 of the body 100 are not provided, and a configuration in which first conductive resin layers 711 and 721 having an L-shape are interposed between second metal layers 412 and 422 and the body 100 may be different.

Accordingly, in describing the embodiment, only the first conductive resin layers 711 and 721 having an L-shape different from the first embodiment will be described, and the description in the first embodiment may be applied for the other components.

Referring to FIG. 9, the coil component 4000 according to the embodiment may further include first conductive resin layers 711 and 721 disposed between the external electrodes 410 and 420 and the body 100. In the embodiment, functions of the adhesive layers 610 and 620 in the first embodiment may also be replaced with the first conductive resin layers 711 and 721, such that the adhesive layers 610 and 620 may not be provided.

The first conductive resin layers 711 and 721 in the embodiment may be disposed on the body 100 and may be connected to the lead-out portions 331 and 332. Also, the first conductive resin layers 711 and 721 may connect the lead-out portions 331 and 332 to the external electrodes 410 and 420.

Also, the first conductive resin layers 711 and 721 may be disposed between the lead-out portions 331 and 332 and the second metal layers 412 and 422 of the external electrodes 410 and 420, and at least a portion may extend to the third surface 103 of the body 100.

The first conductive resin layers 711 and 721 in the embodiment may be formed as a layer including a resin and a metal component dispersed in the resin. The resin may be a thermosetting resin and may include epoxy. The metal components may include silver (Ag) or copper (Cu) components. As an example, in the embodiment the first conductive resin layer 711 and 721 may be an Ag epoxy layer or a Cu epoxy layer, but an embodiment thereof is not limited thereto.

The first conductive resin layer 711 and 721 may include a metal component and a current may flow, and the first conductive resin layer 711 and 721 may include a resin component having flexibility and elasticity, such that the first conductive resin layer 711 and 721 may have stronger properties against vibrations or external impacts than the metal layer.

Also, in the coil component 4000 according to the embodiment, the first conductive resin layers 711 and 721 may be directly disposed on the body 100, coupling force and flexibility between the body 100 and the external electrodes 410 and 420 may be strengthened by coupling between the resin components of body 100 and the resin components of the first conductive resin layers 711 and 721.

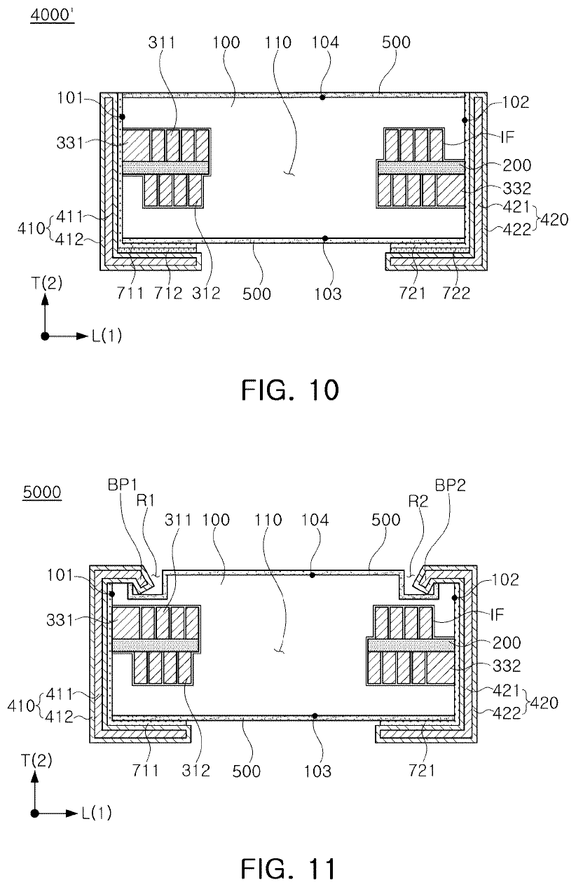

FIG. 10 is a diagram illustrating an L-T cross-section of a coil component according to a modified example of a fourth embodiment, corresponding to FIG. 9.

When comparing FIG. 10 with FIG. 9, a region disposed on a third surface 103 of a body 100 in first conductive resin layers 711 and 721, and a configuration in which the second conductive resin layers 712 and 722 are further disposed between the second metal layers 412 and 422 may be different from the fourth embodiment.

Accordingly, in describing the modified example, only the second conductive resin layers 712 and 722, which are different from the fourth embodiment, will be described, and the description in the fourth embodiment may be applied for the other components.

Referring to FIG. 10, a coil component 4000′ according to the modified example may include a plurality of conductive resin layers extending to the third surface 103 of the body 100.

Specifically, the first conductive resin layers 711 and 721 may be disposed on the first surface 101 of the body 100, a portion may extend to the third surface 103, and the first conductive resin layers 711 and 721 may be disposed on the third surface 103. A second conductive resin layer 712 and 722 may be further disposed on the extended region.

The second conductive resin layers 712 and 722 in the embodiment may be formed of a layer including a resin and a metal component dispersed in the resin. The resin may be a thermosetting resin and may include epoxy. The metal component may include silver (Ag) or copper (Cu) components. As an example, in the embodiment, the second conductive resin layer 712 and 722 may be an Ag epoxy layer or a Cu epoxy layer but an embodiment thereof is not limited thereto.

The coil component 4000′ according to the modified example may be mounted on a circuit substrate among the external electrodes 410 and 420, and a conductive resin layer having a two-layer structure of the first conductive resin layers 711 and 721 and the second conductive resin layers 712 and 722 may be disposed in the pad portion, which is a portion in which stress is concentrated, such that coupling force between the body 100 and the external electrodes 410 and 420 may be strengthened.

Also, due to flexibility and elasticity of the resin component of the conductive resin layer, the components may become storing against vibrations and external impacts, and by disposing the second conductive resin layers 712 and 722 only on the pad portion region, direct current resistance (R_{dc}) characteristics between the lead-out portions 331 and 322 and the external electrodes 410 and 420 may not deteriorate.

### Fifth Embodiment and Modified Example

FIG. 11 is a diagram illustrating an L-T cross-section of a coil component according to a fifth embodiment, corresponding to FIG. 9.

When comparing FIG. 11 with FIG. 9, the coil component 5000 according to the embodiment may be different from the fourth embodiment in terms of a configuration in which recesses R1 and R2 are formed on a body 100, and a configuration in which bent portions BP1 and BP2 includes external electrodes 410 and 420 extending to recesses R1 and R2.

Accordingly, in describing the embodiment, only the recesses R1, R2, and the bent portions BP1 and BP2 extended to the recesses R1 and R2, which are different from the fourth embodiment, will be described, and the description in the fourth embodiment may be applied for the other components.

Referring to FIG. 11, an upper surface of the body 100, that is, the fourth surface 104, may include at least one recess R1 and R2. The recesses R1 and R2 in the embodiment may be formed in the body 100 and may further generate physical fixing force between the body 100 and the external electrodes 410 and 420 by accommodating a portion of the external electrodes 410 and 420.

At least a portion of the external electrodes 410 and 420 may extend into the recesses R1 and R2. Also, the recesses R1 and R2 may be spaced apart from the first surface 101 and the second surface 102 of the body 100, respectively. Also, the recesses R1 and R2 may extend to the fifth surface 105 and the sixth surface 106 of the body 100.

Specifically, the first and second recesses R1 and R2 may be formed on the fourth surface 104 of the body 100 in the embodiment, the first recess R1 may be spaced apart from the first surface 101 of the body 100 at a predetermined distance, and may accommodate and secure at least a portion of the first external electrode 410 end. Similarly, the second recess R2 may be spaced apart from the second surface 102 of the body 100 at a predetermined distance, and may accommodate and secure at least a portion of the end of the second external electrode 420.

Referring to FIG. 11, the external electrodes 410 and 420 in the embodiment may include bent portions BP1 and BP2 formed on one end, and the bent portions BP1 and BP2 may be bent toward the recesses R1 and R2.

Specifically, the first external electrode 410 may be disposed on the first surface 101 of the body 100, and the first surface 101 of the body 100 and the first recess R1 may extend to the fourth surface 104 of the body 100 along regions spaced apart from each other, and the extended end may include the first bent portion BPI bent to be accommodated in the first recess R1.

Similarly, the second external electrode 420 may be disposed on the second surface 102 of the body 100, and may extend to the fourth surface 104 of the body 100 along regions in which the second surface 102 and the second recess R2 are spaced apart from each other. The extended end may include a second bent portion BP2 bent to be accommodated in the second recess R2.

The angle at which bent portions BP1 and BP2 are bent may be selected without limitation in the range of more than 0 degrees and less than 180 degrees as long as physical fixing force may be provided between the bent portions BP1 and BP2 and the recesses R1 and R2 at the angle.

In the coil component 5000 according to the embodiment, the recesses R1 and R2 may be formed on the body 100, and as the bent portions BP1 and BP2 formed on ends of the external electrodes 410 and 420 are accommodated in the recesses R1 and R2, additional physical fixing force may be provided between the body 100 and the external electrodes 410 and 420, such that characteristics resistant to external impacts or vibrations may be obtained.

Also, the coil component 5000 according to the embodiment may include the first conductive resin layers 711 and 721 interposed between the external electrodes 410 and 420 and the body 100, such that due to flexibility and elasticity of the resin components of the first conductive resin layer 711 and 721, strong properties against vibration and external impacts may be obtained.

In other words, the coil component 5000 in the embodiment may be mounted on a circuit substrate, and even when exposed to an environment in which vibrations or external impacts occur, due to flexibility and elasticity by the first conductive resin layers 711 and 721, and physical fixation by the recesses R1 and R2 and the bent portions BP1 and BP2, coupling force between the body 100 and the external electrodes 410 and 420 or connection reliability between the coil 300 and the external electrodes 410 and 420 may be further strengthened.

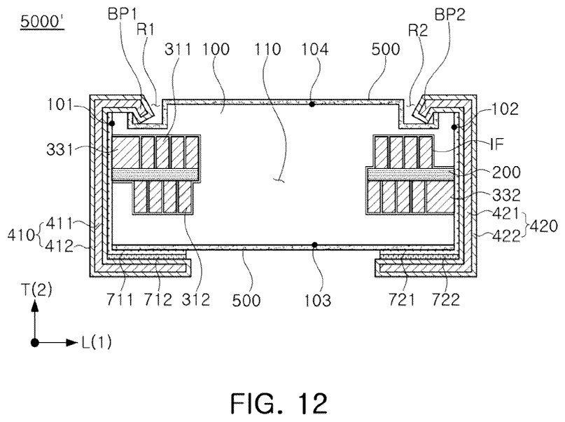

FIG. 12 is a diagram illustrating an L-T cross-section of a coil component according to a modified example of a fifth embodiment, corresponding to FIG. 11.

When comparing FIG. 12 with FIG. 11, the region of the first conductive resin layers 711 and 721 disposed on the third surface 103 of body 100, and a configuration in which second conductive resin layers 712 and 722 are further disposed between second metal layers 412 and 422 may be different from the fifth embodiment.

Accordingly, in describing the modified example, only the second conductive resin layers 712 and 722, which are different from the fifth embodiment, will be described, and the description in the fifth embodiment may be applied for the other components.

Referring to FIG. 12, a coil component 5000′ according to the modified example may include a plurality of conductive resin layers extending to the third surface 103 of the body 100.

Specifically, the first conductive resin layers 711 and 721 may be disposed on the first surface 101 of the body 100, a portion may extend to the third surface 103, and the second conductive resin layers 712 and 722 may be further disposed on the region in which the first conductive resin layers 711 and 721 extend to the third surface 103.

The second conductive resin layers 712 and 722 in the embodiment may be formed of a layer including a resin and a metal component dispersed in the resin. The resin may be a thermosetting resin and may include epoxy. The metal components may include silver (Ag) or copper (Cu) components. As an example, in the embodiment, the second conductive resin layer 712 and 722 may be an Ag epoxy layer or a Cu epoxy layer but an embodiment thereof is not limited thereto.

The coil component 5000′ according to the modified example may be mounted on the circuit substrate in the external electrodes 410 and 420, and a conductive resin layer having a two-layer structure of the first conductive resin layer 711 and 721 and the second conductive resin layer 712 and 722 may be disposed in the pad portion, which is the portion in which stress is concentrated, such that coupling force between the body 100 and the external electrodes 410 and 420 may be strengthened.

Also, due to flexibility and elasticity of the resin component of the conductive resin layer, the component may become stronger against vibrations and external impacts, and by disposing the second conductive resin layers 712 and 722 only on the pad portion region, direct current resistance (R_{dc}) characteristics between the lead-out portions 331 and 322 and the external electrodes 410 and 420 may not deteriorate.

### Processes of Manufacturing Coil Component

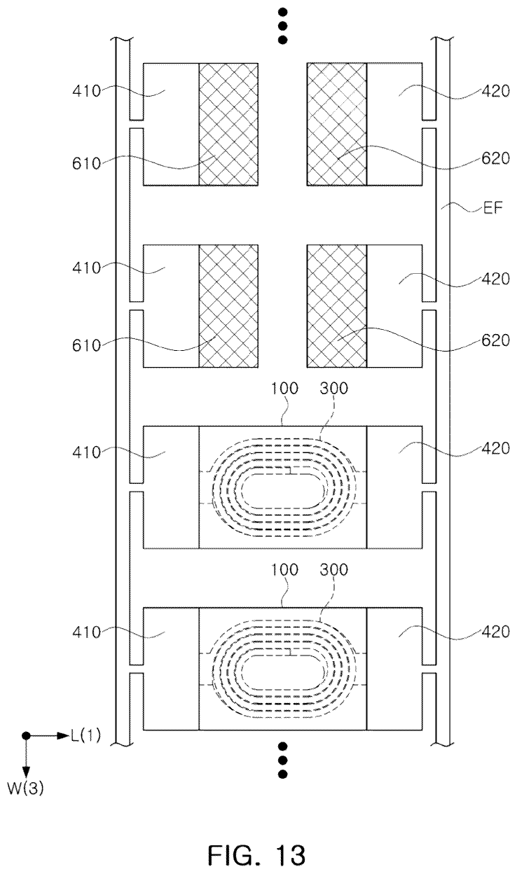

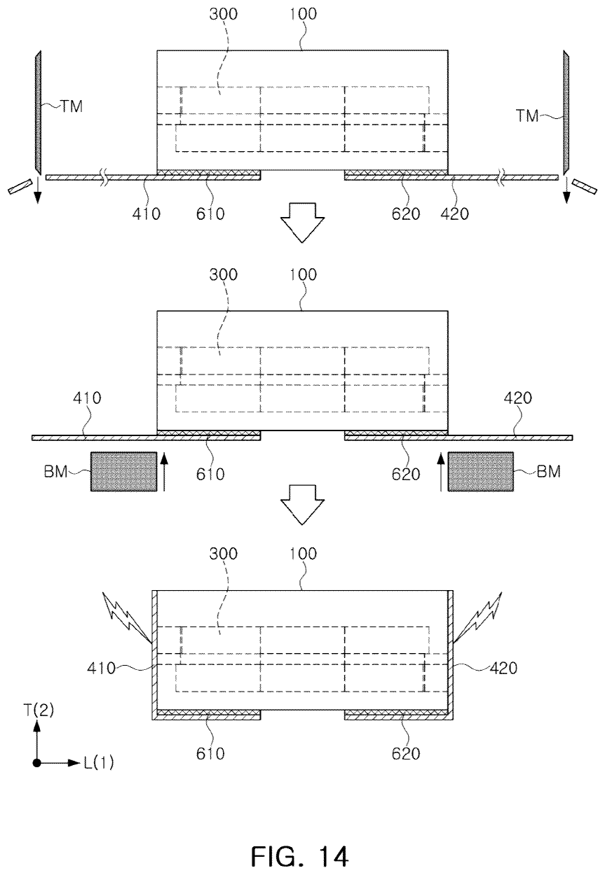

FIGS. 13 and 14 are diagrams illustrating a portion of processes of a method of manufacturing a coil component according to a first embodiment.

Referring to FIG. 13, external electrodes 410 and 420 connected to an electrode frame EF may be formed through a rolling process using a roller. Here, the external electrodes 410 and 420 may be formed by coating a second metal layer on the surface of the first metal layer and performing a rolling process using a roller, but an embodiment thereof is not limited thereto, and the external electrodes 410 and 420 may be formed by first forming the first metal layer through a rolling process and forming the second metal layer on the surface by vapor deposition such as sputtering and/or plating.

Thereafter, the adhesive layers 610 and 620 may be disposed on the pad portion region of the external electrodes 410 and 420 connected to the electrode frame EF, and the body 100 including the coil 300 embedded therein may be loaded.

Here, instead of adhesive layers 610 and 620, a conductive resin layer may be disposed. When disposing the conductive resin layer, the conductive resin layer is not limited to the pad portion region, and may extend and disposed to the region in contact with the lead-out portion of coil 300.

Thereafter, referring to FIG. 14, to form the individual coil component 1000, the external electrodes 410 and 420 connected to the electrode frame EF may be cut using a trimming member TM.

Thereafter, with respect to the portion of the external electrodes 410 and 420 not disposed on the body 100, that is, the region excluding the pad portion, the external electrodes 410 and 420 may be bent and may be close contact with the side surface of the body 100 by applying upward pressure using bending member BM.

Thereafter, the lead-out portion of the coil 300 exposed to the side surface of the body 100 and the external electrodes 410 and 420 may be fused using ultrasonic welding, laser welding, or resistance welding.

According to the aforementioned embodiments, connection reliability between the coil and the external electrode in the coil component may be maintained despite vibrations or external impacts.

According to another aspect, by including a structure in which one region on an end of the external electrode is bent toward a recess formed in the body, physical coupling force between the body and the external electrode may be strengthened.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a first surface and a second surface opposing each other in a first direction, and a third surface connecting the first surface to the second surface;
a coil disposed in the body and including a lead-out portion led out to the first surface or the second surface; and
an external electrode disposed on the body and connected to the lead-out portion and including a first metal layer and a second metal layer,
wherein the first metal layer includes a first side surface facing the body and a second side surface opposing the first side surface, and
wherein the second metal layer is disposed on each of the first side surface and the second side surface of the first metal layer.

2. The coil component of claim 1, wherein the first metal layer is coated with the second metal layer.

3. The coil component of claim 1, wherein the second metal layer surrounds the first metal layer on a cross-section perpendicular to the first surface and the third surface.

4. The coil component of claim 1, wherein the first metal layer includes copper (Cu).

5. The coil component of claim 1, wherein the second metal layer includes nickel (Ni).

6. The coil component of claim 1, wherein a metal included in the lead-out portion and a metal included in the second metal layer have a homogeneous solid solution in a mutually contacted region.

7. The coil component of claim 6, wherein a point at which a content ratio between a metal included in the lead-out portion and a metal included in the second metal layer is 1:1 is present in a region having the homogeneous solid solution.

8. The coil component of claim 1, wherein a long axis direction of grain included in the first metal layer is aligned parallel to a surface of the body.

9. The coil component of claim 8, wherein an internal angle formed by the long axis of the grain included in the first metal layer and a conceptual extended line is 80 degrees or more and 110 degrees or less with respect to the extended line penetrating through the body and parallel to the first direction.

10. The coil component of claim 1, wherein a grain included in the first metal layer, disposed on one of the first to third surface of the body, has a long axis aligned parallel to the one of the first to third surface of the body.

11. The coil component of claim 1, further comprising:
a support member disposed in the body and supporting the coil.

12. The coil component of claim 1, further comprising:
an insulating layer disposed on the third surface of the body,
wherein at least a portion of the insulating layer extends to a region between the third surface of the body and the external electrode.

13. The coil component of claim 1, further comprising:
a third metal layer disposed between the lead-out portion and the second metal layer.

14. The coil component of claim 13, wherein the third metal layer covers at least one of the first surface and the second surface.

15. The coil component of claim 13, wherein the third metal layer includes copper (Cu).

16. The coil component of claim 13, wherein a metal included in the third metal layer and a metal included in the second metal layer have a homogeneous solid solution in regions in contact with each other.

17. The coil component of claim 16, wherein a point at which a content ratio between a metal included in the third metal layer and a metal included in the second metal layer is 1:1 is present in a region having the homogeneous solid solution.

18. The coil component of claim 13,
wherein the body further includes a fourth surface opposing the third surface,
wherein the fourth side includes at least one recess, and
wherein at least a portion of the external electrode extends to the recess.

19. The coil component of claim 18, wherein the recess is spaced apart from each of the first surface and the second surface.

20. The coil component of claim 18, wherein the external electrode includes a bent portion as one end, and the bent portion is bent toward the recess.

21. The coil component of claim 18, further comprising:
an adhesive layer disposed between the third surface of the body and the external electrode.

22. The coil component of claim 21, wherein the adhesive layer includes a conductive paste.

23. The coil component of claim 13, further comprising:
an adhesive layer disposed between the third surface of the body and the external electrode.

24. The coil component of claim 23, wherein the adhesive layer includes a conductive paste.

25. The coil component of claim 1, further comprising:
an adhesive layer disposed between the third surface of the body and the external electrode.

26. The coil component of claim 25, wherein the adhesive layer includes a conductive paste.

27. A coil component, comprising:
a body including a first surface and a second surface opposing each other in a first direction, and a third surface connecting the first surface to the second surface;
a coil disposed in the body and including a lead-out portion led out to the first surface or the second surface;
a conductive resin layer disposed on the body and connected to the lead-out portion; and
an external electrode disposed on the conductive resin layer and including a first metal layer and a second metal layer,
wherein the first metal layer includes a first side surface facing the body and a second side surface opposing the first side surface,
wherein the second metal layer is disposed on each of the first side surface and the second side surface of the first metal layer, and
wherein the conductive resin layer is disposed between the lead-out portion and the second metal layer, and includes at least a portion extending to the third surface.

28. The coil component of claim 27, wherein a plurality of conductive resin layers extending to the third surface are included.

29. The coil component of claim 27, wherein the conductive resin layer includes at least one of silver (Ag) or copper (Cu).

30. The coil component of claim 27, wherein the first metal layer includes copper (Cu), and the second metal layer includes nickel (Ni).

31. The coil component of claim 27, wherein a long axis direction of a grain included in the first metal layer is aligned parallel to a surface of the body.

32. The coil component of claim 31, wherein an internal angle formed by the long axis of the grain included in the first metal layer and the extended line is 80degrees or more and 110 degrees or less with respect to a conceptual extended line penetrating through the body and parallel to the first direction.

33. The coil component of claim 27,
wherein the body includes at least one recess, and
wherein one end of the external electrode is bent along a surface of the body and is inserted into a recess.

34. The coil component of claim 27, wherein a grain included in the first metal layer, disposed on one of the first to third surface of the body, has a long axis aligned parallel to the one of the first to third surface of the body.

35. A coil component, comprising:
a body including a first surface and a second surface opposing each other in a first direction, and a third surface connecting the first surface to the second surface;
a coil disposed in the body and including a lead-out portion led out to the first surface;
an external electrode disposed on the first surface and the third surface to connect to the lead-out portion; and
an adhesive layer disposed between the third surface of the body and the external electrode,
wherein a grain included in the external electrode, disposed on the first surface of the body, has a long axis aligned parallel to the first surface of the body.

36. The coil component of claim 35, wherein an internal angle formed by the long axis of the grain included in the external electrode disposed on the first surface of the body and a conceptual extended line is 80 degrees or more and 110 degrees or less with respect to the extended line penetrating through the body and parallel to the first direction.

37. The coil component of claim 35, wherein the grain is a copper (Cu) grain.

38. The coil component of claim 37, wherein the external electrode also includes nickel (Ni).

39. The coil component of claim 38, further comprising a homogeneous solid solution of Ni and Cu in a region between the Cu grain and the lead-out portion.

40. The coil component of claim 35, wherein the adhesive layer extends from the third surface to cover at least a portion of the first surface.

41. The coil component of claim 40, wherein the adhesive layer is a conductive resin layer.

42. The coil component of claim 41, wherein the conductive resin layer includes an Ag epoxy layer or a Cu epoxy layer.

43. A coil component, comprising:
a body including a first surface and a second surface opposing each other in a first direction, and a third surface and a fourth surface opposing each other and connected to the first surface and the second surface;
a coil disposed in the body and including a lead-out portion led out to the first surface;
an external electrode disposed on the first surface, on the third surface to connect to the lead-out portion, and on the fourth source; and
an adhesive layer disposed between the third surface of the body and the external electrode,
wherein an end portion of the external electrode is disposed in a recess in the fourth surface.

44. The coil component of claim 43, wherein among the third surface and the fourth surface, the recess is disposed only in the fourth surface.

45. The coil component of claim 44, wherein the end portion of the external electrode disposed in the recess in the fourth surface includes a portion spaced apart from a wall surface of the recess, and
wherein the wall surface of the recess is closer to the first surface as compared to the portion of the end portion which is spaced apart from the wall surface of the recess.

46. The coil component of claim 43, wherein the adhesive layer extends from the third surface to cover at least a portion of the first surface.

47. The coil component of claim 46, wherein the adhesive layer is spaced apart from the recess.

48. The coil component of claim 46, wherein the adhesive layer is a conductive resin layer.

49. The coil component of claim 48, wherein the conductive resin layer includes an Ag epoxy layer or a Cu epoxy layer.

50. The coil component of claim 47, wherein the external electrode includes copper (Cu) and nickel (Ni).

51. The coil component of claim 50, further comprising a homogeneous solid solution of Ni and Cu in a region between the lead-out portion and a copper grain included in the external electrode.
